(19) United States
(12) Patent Application Publication
(10) Pub. No.: US 2025/0180751 A1
(43) Pub. Date: Jun. 5, 2025

(54) UNMANNED AERIAL DEVICE AND OPERATION METHOD THEREOF

(71) Applicant: Metal Industries Research & Development Centre, Kaohsiung (TW)

(72) Inventors: Kuang-Shine Yang, Tainan City (TW); Chao Chieh Hsu, Kaohsiung City (TW)

(73) Assignee: Metal Industries Research & Development Centre, Kaohsiung (TW)

(21) Appl. No.: 18/527,370

(22) Filed: Dec. 4, 2023

(51) Int. Cl. G01S 17/933; B64U 20/87; G08G 5/04

(52) U.S. Cl. CPC G01S 17/933; B64U 20/87; G08G 5/80; B64U 2201/10

(57) ABSTRACT

An unmanned aerial device and an operation method thereof are provided. The unmanned aerial device includes a plurality of optical radars, a visual sensing module, an edge operator, and a flight controller. The plurality of optical radars generate a plurality of ranging data. The visual sensing module executes a simultaneous localization and mapping to generate obstacle distance data, six-axis acceleration data, and spatial coordinate data. The edge operator performs spatial coordinate conversion on the obstacle distance data, the six-axis acceleration data, and the spatial coordinate data. The flight controller controls the unmanned aerial vehicle to perform obstacle avoidance operation according to the plurality of ranging data, the obstacle distance data, the six-axis acceleration data, and the spatial coordinate data.

### BACKGROUND

### Technical Field

The disclosure relates to a device, and particularly to an unmanned aerial device and an operation method thereof.

### Description of Related Art

General drone control systems use positioning coordinates to control the drone to fly to a specific position or execute a specific flight trajectory. However, when there are obstacles in the flight environment or when a plurality of drones are operating cooperatively, collisions and damage are often prone to occur because there is no anti-collision mechanism.

### SUMMARY

The disclosure provides an unmanned aerial device and an operation method thereof, which enable the unmanned aerial device to effectively avoid obstacles during flight.

An unmanned aerial device of the disclosure includes a plurality of optical radars, a visual sensing module, an edge operator, and a flight controller. The plurality of optical radars are configured to generate a plurality of ranging data. The visual sensing module is configured to execute a simultaneous localization and mapping to generate obstacle distance data, six-axis acceleration data, and spatial coordinate data. The edge operator is coupled to the visual sensing module to perform spatial coordinate conversion on the obstacle distance data, the six-axis acceleration data, and the spatial coordinate data. The flight controller is coupled to the plurality of optical radars and the edge operator, and is configured to control the unmanned aerial device to perform obstacle avoidance operation according to the plurality of ranging data, the obstacle distance data, the six-axis acceleration data, and the spatial coordinate data.

An operation method of the unmanned aerial device of the disclosure includes the following steps. A plurality of ranging data is generated by a plurality of optical radars. A simultaneous localization and mapping is executed by a visual sensing module to generate obstacle distance data, six-axis acceleration data, and spatial coordinate data. A spatial coordinate conversion is performed on the obstacle distance data, the six-axis acceleration data, and the spatial coordinate data by an edge operator. The unmanned aerial device is controlled by a flight controller to perform obstacle avoidance operation according to the plurality of ranging data, the obstacle distance data, the six-axis acceleration data, and the spatial coordinate data.

Based on the above, the unmanned aerial device and the operation method thereof of the disclosure can effectively detect obstacles through the optical radar and generate the obstacle distance data, so that the unmanned aerial device can effectively avoid obstacles during flight.

In order to make the above-mentioned features and advantages of the disclosure clearer and easier to understand, the following embodiments are given and described in details with accompanying drawings as follows.

### BRIEF DESCRIPTION OF THE DRAWINGS

FIG. 1 is a schematic circuit diagram of an unmanned aerial device according to an embodiment of the disclosure.

FIG. 2 is a schematic structural diagram of an unmanned aerial device according to an embodiment of the disclosure.

FIG. 3 is a flowchart of an operation method of an unmanned aerial device according to an embodiment of the disclosure.

FIG. 4 is a schematic diagram of a data processing flow according to an embodiment of the disclosure.

FIG. 5 is a schematic diagram of two unmanned aerial devices performing coordinated transportation operation according to an embodiment of the disclosure.

### DESCRIPTION OF THE EMBODIMENTS

In order to make the content of the disclosure more comprehensible, embodiments are described below as examples according to which the disclosure can indeed be implemented. In addition, wherever possible, elements/components/steps with same reference numerals in the drawings and implementations represent same or similar parts.

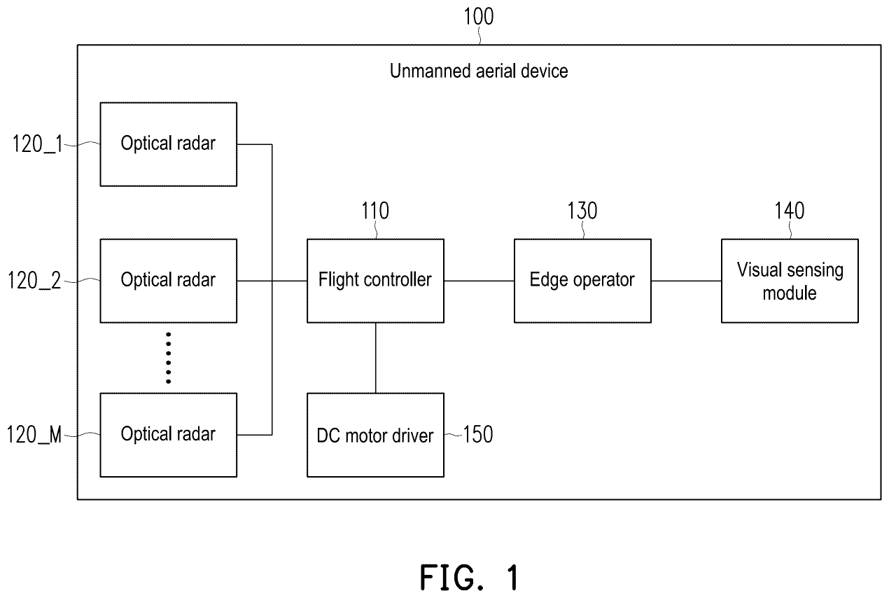

FIG. 1 is a schematic circuit diagram of an unmanned aerial device according to an embodiment of the disclosure. An unmanned aerial device 100 includes a flight controller 110, optical radars 120_1 to 120_M, an edge operator 130, a visual sensing module 140, and a DC motor driver 150, where M is a positive integer. The flight controller 110 is coupled to the optical radars 120_1 to 120_M, the edge operator 130, and the DC motor driver 150. The edge operator 130 is coupled to the visual sensing module 140.

In the embodiment, the flight controller 110 is configured to implement the vehicle motion control function. The flight controller 110 may, for example, include a central processing unit (CPU), or other programmable general-purpose or special-purpose microprocessors, a digital signal processor (DSP), an image processing unit (IPU), a graphics processing unit (GPU), a programmable controller, a microcontroller unit (MCU), an application specific integrated circuit (ASIC), a programmable logic device (PLD), other similar processing devices, or a combination thereof. The software framework of the flight controller 110 can be developed using an open source algorithm (ArduCopter).

In the embodiment, the edge operator 130 can implement arobot operating system (ROS) through the NVIDIA Jetson Nano development kit, and can be configured to implement operations such as communication protocol conversion and spatial coordinate conversion. In the embodiment, the visual sensing module 140 may include an image sensor, a plurality of infrared sensors, and other related sensors, but the disclosure is not limited thereto. The visual sensing module 140 can be configured to execute a simultaneous localization and mapping (SLAM), and can also obtain spatial coordinate information, six-axis acceleration, distance to obstacles ahead, and mark visual recognition results.

In the embodiment, the DC motor driver 150 may be configured to drive one or more DC motors of the unmanned aerial device 100 to drive related flight units of the unmanned aerial device 100, such as propellers. In the embodiment, the flight controller 110 can respectively communicate with the optical radars 120_1 to 120_M and the edge operator 130 through a MAVLink protocol. In addition, in the embodiment, the unmanned aerial device 100 may also include necessary devices and circuits related to the unmanned aerial vehicle to implement the unmanned flying function, and the disclosure is not limited thereto.

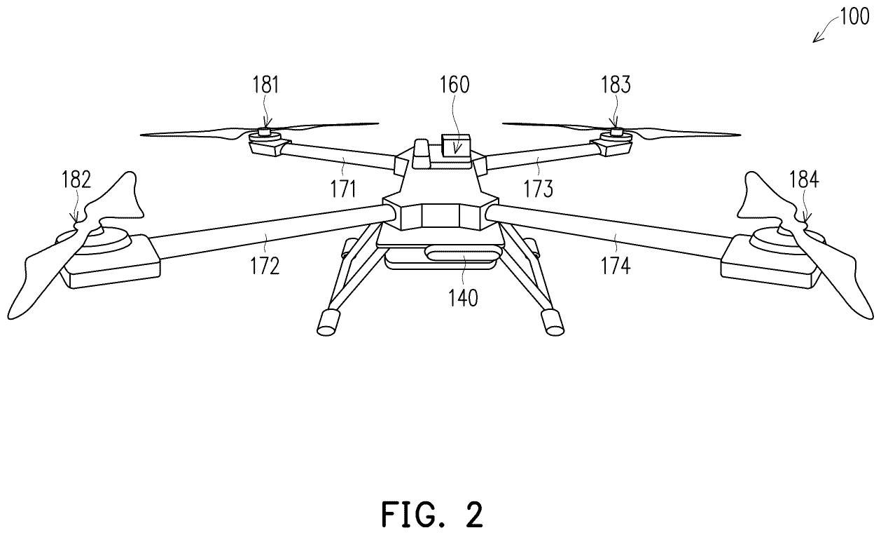

FIG. 2 is a schematic structural diagram of an unmanned aerial device according to an embodiment of the disclosure. Referring to FIG. 1 and FIG. 2, for example, the unmanned aerial device 100 may further include a device body 160, four brackets 171 to 174, and four propellers 181 to 184. The four brackets 171 to 174 are installed on the device body 160, and the four propellers 181 to 184 are respectively installed on the four brackets 171 to 174. In the embodiment, the visual sensing module 140 may be disposed on a front side of the device body 160 and perform sensing towards the ground. The optical radars 120_1 to 120_M may be disposed on at least one of the front, back, left, right, upper, and lower sides of the device body 160 for detecting the distance to surrounding obstacles (if any). In the embodiment, the edge operator 130 and the DC motor driver 150 may be disposed in the device body 160.

In an embodiment, the optical radars 120_1 to 120_M may include a first optical radar and a second optical radar. The first optical radar and the second optical radar may be disposed on the left and right sides of the device body 160 of the unmanned aerial device 100. The first optical radar may be configured to sense in a first horizontal direction, and the second optical radar may be configured to sense in a second horizontal direction. The first horizontal direction is opposite to the second horizontal direction. In an embodiment, the optical radars 120_1 to 120_M may also include a third optical radar and a fourth optical radar. The third optical radar and the fourth optical radar may be disposed on the upper and lower sides of the device body 160 of the unmanned aerial device 100. The third optical radar can be configured to sense in a first vertical direction, and the fourth optical radar can be configured to sense in a second vertical direction. The first vertical direction is opposite to the second vertical direction.

In the embodiment, the visual sensing module 140 can also be configured to detect a positioning pattern disposed on the ground to perform a precise landing operation. The positioning pattern can be, for example, a checkerboard pattern. The visual sensing module 140 can provide relevant distance information and orientation information of the positioning pattern for the flight controller 110 to consider simultaneously when determining posture control data and position control data, so that the unmanned aerial device 100 can move toward the positioning pattern and land on the positioning pattern or a relative position thereof.

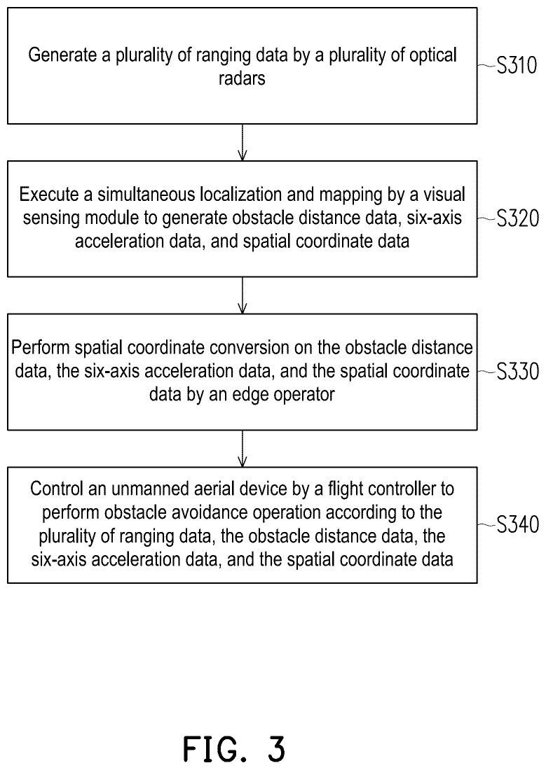

FIG. 3 is a flowchart of an operation method of an unmanned aerial device according to an embodiment of the disclosure. Referring to FIG. 1 and FIG. 3, the unmanned aerial device 100 may perform the following steps S310 to S350. In step S310, during the flight of the unmanned aerial device 100, the flight controller 110 may generate a plurality of ranging data through the optical radars 120_1 to 120_M. In step S320, the visual sensing module 140 may execute a simultaneous localization and mapping to generate obstacle distance data, six-axis acceleration data, and spatial coordinate data. In step S330, the edge operator 130 may perform spatial coordinate conversion on the obstacle distance data, the six-axis acceleration data, and the spatial coordinate data. In step S340, the flight controller 110 may control the unmanned aerial device 100 to perform obstacle avoidance operation (i.e., implement an anti-collision function) according to the plurality of ranging data, the obstacle distance data, the six-axis acceleration data, and the spatial coordinate data.

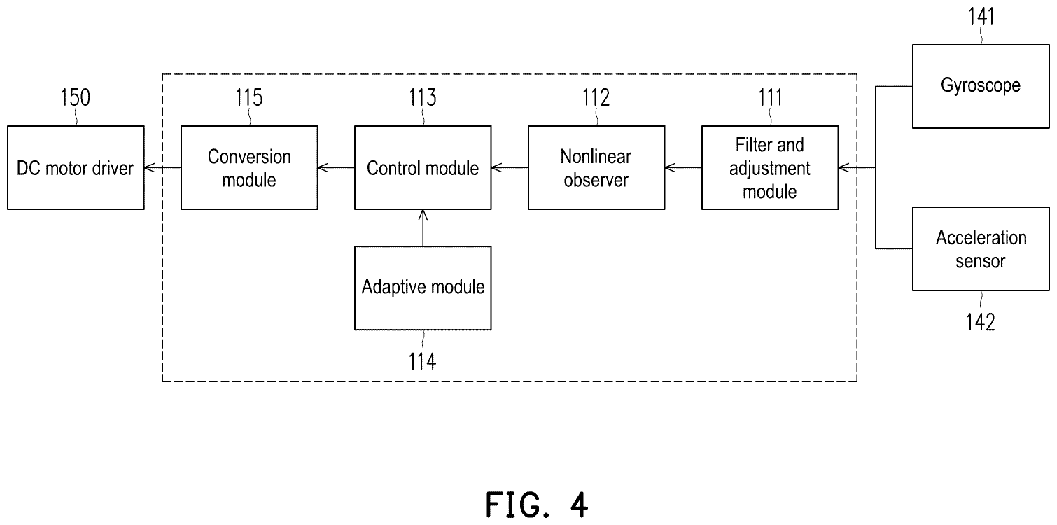

FIG. 4 is a schematic diagram of a data processing flow according to an embodiment of the disclosure. Referring to FIG. 1 and FIG. 4, the flight controller 110 may further include a storage device (not shown). The storage device may include a memory. The memory may be, for example, a non-volatile memory such as a read only memory (ROM), an erasable programmable read only memory (EPROM), etc., a volatile memory such as a random access memory (RAM), etc., and a memory such as hard disc drive, a semiconductor memory, etc., and may be configured to store various modules, images, information, parameters, data, etc. mentioned in the disclosure. In the embodiment, the storage device can store a filter and adjustment module 111, a nonlinear observer 112, a control module 113, an adaptive module 114, and a conversion module 115. The flight controller 110 may execute the filter and adjustment module 111, the nonlinear observer 112, the control module 113, the adaptive module 114, and the conversion module 115.

In the embodiment, the visual sensing module 140 can also be used with a gyroscope 141 and an acceleration sensor 142 to provide the six-axis acceleration data and the spatial coordinate data. The flight controller 110 can generate current position data and current posture data of the unmanned aerial device 100 according to the six-axis acceleration data and the spatial coordinate data. The flight controller 110 can perform, for example, low pass filter, moving average filter, and adjustment matrix operation on the current position data and the current posture data through the filter and adjustment module 111. Then, the flight controller 110 can execute the nonlinear observer 112 according to the position data to perform trajectory prediction and generate position prediction data. The nonlinear observer 112 may be a slide mode observer. The flight controller 110 can execute the control module 113 to generate the posture control data according to the posture data and the position prediction data based on an adaptive control parameter adjustment method, and generate the position control data according to the posture control data and the obstacle distance data. The adaptive control parameter adjustment method means that the control parameters can be adjusted by constructing a recursive operation mode through a limited time convergence rule. Therefore, the flight controller 110 can execute the conversion module 115 to convert the posture control data and the position control data into a real input matrix format to drive the DC motor driver 150. In this way, the unmanned aerial device 100 can perform effective flight operation, and the flight position of the unmanned aerial device 100 can be adaptively adjusted in real time according to the distance from the obstacle to implement an effective anti-collision function.

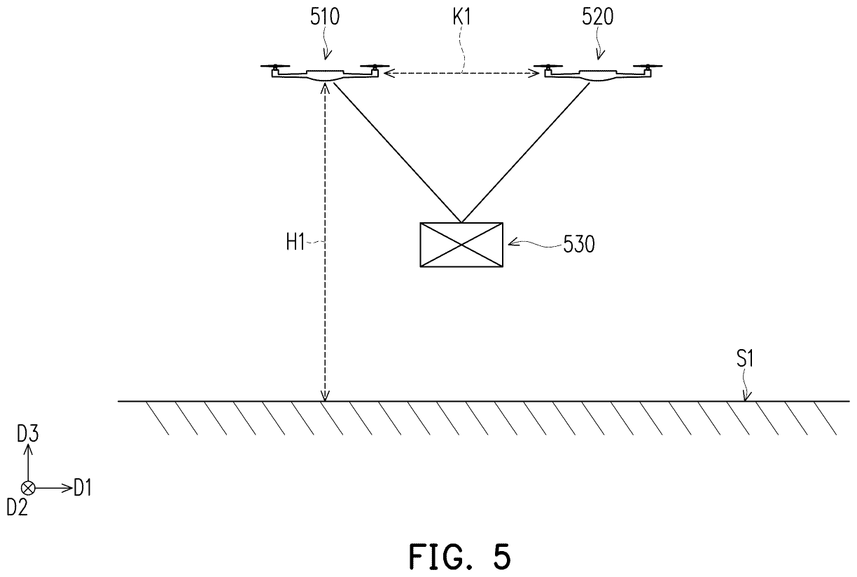

FIG. 5 is a schematic diagram of two unmanned aerial devices performing coordinated transportation operation according to an embodiment of the disclosure. Referring to FIG. 5, in the context of two unmanned aerial devices 510 and 520 performing coordinated transportation operations, the unmanned aerial devices 510 and 520 can respectively implement the flight control and anti-collision functions as shown in FIG. 1 to FIG. 4 above. Specifically, a ground surface S1 is parallel to a plane formed by extending a direction D1 and a direction D2 respectively, and the directions D1 and D2 and a direction D3 are perpendicular to each other. The direction D3 is a vertical direction. The unmanned aerial devices 510 and 520 can perform coordinated transportation. In this regard, since the weight of a cargo 530 may affect the flight of the unmanned aerial devices 510 and 520, the unmanned aerial devices 510 and 520 need to dynamically adjust the flight posture and position.

The unmanned aerial devices 510 and 520 can obtain the obstacle distance data through their respective left or right optical radars. The obstacle distance data is a distance K1 between the unmanned aerial device 510 and the unmanned aerial device 520. In this regard, the flight controllers of the unmanned aerial device 510 and the unmanned aerial device 520 can control the unmanned aerial device 510 and the unmanned aerial device 520 according to the distance K1, so as to maintain a preset distance between the unmanned aerial device 510 and the unmanned aerial device 520. The unmanned aerial device 510 and the unmanned aerial device 520 can respectively generate the current position data and the current posture data of the unmanned aerial device 510 and the unmanned aerial device 520 according to their respective six-axis acceleration data and spatial coordinate data. The unmanned aerial device 510 and the unmanned aerial device 520 can generate their respective posture control data according to their respective posture data and position prediction data based on the adaptive control parameter adjustment method, and can generate their respective position control data according to their respective posture control data and the distance K1.

Furthermore, the unmanned aerial devices 510 and 520 can obtain a current flight height H1 through their respective lower optical radars. In this regard, the flight controllers of the unmanned aerial device 510 and the unmanned aerial device 520 can control the unmanned aerial device 510 and the unmanned aerial device 520 according to the current flight height H1. The unmanned aerial device 510 and the unmanned aerial device 520 can respectively maintain a same flight height according to a same preset flight height setting. Therefore, the unmanned aerial devices 510 and 520 can implement stable coordinated transportation operation.

In an embodiment, the unmanned aerial device 510 and the unmanned aerial device 520 can communicate. The unmanned aerial device 510 can perform flight operation according to the preset flight height setting, and the unmanned aerial device 510 can provide current flight height information to the unmanned aerial device 520 in real time, so that the unmanned aerial device 520 can follow the current flight height of the unmanned aerial device 510 according to the current flight height information of the unmanned aerial device 510. In this regard, the unmanned aerial device 520 can correct its flight height in real time according to the current flight height information of the unmanned aerial device 510 (for example, the current flight height H1), and can use the optical radars as described in the above embodiments to maintain a preset distance from the unmanned aerial device 510. In this way, the unmanned aerial device 510 and the unmanned aerial device 520 can maintain a same flight height to implement stable coordinated transportation operations.

In summary, the unmanned aerial device and the operation method thereof of the disclosure can effectively detect the obstacle distance data through the optical radars, and can simultaneously consider the obstacle distance data and the six-axis acceleration data and the spatial coordinate data of the unmanned aerial device to control the flight path of the unmanned aerial vehicle.

Although the disclosure has been described with reference to the embodiments above, the embodiments are not intended to limit the disclosure. Any person skilled in the art can make some changes and modifications without departing from the spirit and scope of the disclosure. Therefore, the scope of the disclosure will be defined in the appended claims.

What is claimed is:

1. An unmanned aerial device, comprising:
a plurality of optical radars, configured to generate a plurality of ranging data;
a visual sensing module, configured to execute a simultaneous localization and mapping to generate obstacle distance data, six-axis acceleration data, and spatial coordinate data;
an edge operator, coupled to the visual sensing module, and configured to perform spatial coordinate conversion on the obstacle distance data, the six-axis acceleration data, and the spatial coordinate data; and
a flight controller, coupled to the optical radars and the edge operator, and configured to control the unmanned aerial device to perform obstacle avoidance operation according to the ranging data, the obstacle distance data, the six-axis acceleration data, and the spatial coordinate data.

2. The unmanned aerial device according to claim 1, further comprising:
a DC motor driver, coupled to the flight controller,
wherein the flight controller generates position data and posture data according to the six-axis acceleration data and the spatial coordinate data, and the flight controller executes a nonlinear observer according to the position data to perform trajectory prediction and generate a position prediction data,
wherein the flight controller generates posture control data according to the posture data and the position prediction data, and the flight controller generates position control data according to the posture control data and the obstacle distance data,
wherein the flight controller drives the DC motor driver according to the posture control data and the position control data.

3. The unmanned aerial device according to claim 2, wherein the nonlinear observer is a slide mode observer.

4. The unmanned aerial device according to claim 1, wherein the optical radars comprise a first optical radar and a second optical radar, the first optical radar is configured to sense in a first horizontal direction, the second optical radar is configured to sense in a second horizontal direction, and the first horizontal direction is opposite to the second horizontal direction.

5. The unmanned aerial device according to claim 4, wherein the optical radars comprise a third optical radar and a fourth optical radar, the third optical radar is configured to sense in a first vertical direction, the fourth optical radar is configured to sense in a second vertical direction, and the first vertical direction is opposite to the second vertical direction.

6. The unmanned aerial device according to claim 1, wherein the unmanned aerial device and another unmanned aerial device perform coordinated transportation operation, and the obstacle distance data is distance data between the unmanned aerial device and the another unmanned aerial device,
wherein the flight controller controls the unmanned aerial device according to the obstacle distance data, so as to maintain a preset distance between the unmanned aerial device and the another unmanned aerial device.

7. The unmanned aerial device according to claim 6, wherein the unmanned aerial device and the another unmanned aerial device respectively maintain a same flight height according to a same preset flight height setting.

8. The unmanned aerial device according to claim 1, wherein the visual sensing module comprises an image sensor and a plurality of infrared sensors.

9. An operation method of an unmanned aerial device, comprising:
generating a plurality of ranging data by a plurality of optical radars;
executing a simultaneous localization and mapping by a visual sensing module to generate obstacle distance data, six-axis acceleration data, and spatial coordinate data;
performing spatial coordinate conversion on the obstacle distance data, the six-axis acceleration data, and the spatial coordinate data by an edge operator; and
controlling the unmanned aerial device to perform obstacle avoidance operation according to the ranging data, the obstacle distance data, the six-axis acceleration data, and the spatial coordinate data by a flight controller.

10. The operation method according to claim 9, further comprising:
generating position data and posture data according to the six-axis acceleration data and the spatial coordinate data by the flight controller;
executing a nonlinear observer to perform trajectory prediction and generate position prediction data according to the position data by the flight controller,
generating posture control data according to the posture data and the position prediction data by the flight controller;
generating position control data according to the posture control data and the obstacle distance data by the flight controller; and
driving a DC motor driver according to the posture control data and the position control data by the flight controller.

11. The operation method according to claim 10, wherein the nonlinear observer is a slide mode observer.

12. The operation method according to claim 9, wherein the optical radars comprise a first optical radar and a second optical radar, the first optical radar is configured to sense in a first horizontal direction, the second optical radar is configured to sense in a second horizontal direction, and the first horizontal direction is opposite to the second horizontal direction.

13. The operation method according to claim 12, wherein the optical radars comprise a third optical radar and a fourth optical radar, the third optical radar is configured to sense in a first vertical direction, the fourth optical radar is configured to sense in a second vertical direction, and the first vertical direction is opposite to the second vertical direction.

14. The operation method according to claim 9, wherein the unmanned aerial device and another unmanned aerial device perform coordinated transportation operation, and the obstacle distance data is distance data between the unmanned aerial device and the another unmanned aerial device, the operation method further comprising:
controlling the unmanned aerial device according to the obstacle distance data by the flight controller, so as to maintain a preset distance between the unmanned aerial device and the another unmanned aerial device.

15. The operation method according to claim 14, wherein the unmanned aerial device and the another unmanned aerial device respectively maintain a same flight height according to a same preset flight height setting.
